(19) United States
(12) Patent Application Publication
(10) Pub. No.: US 2021/0220900 A1
(43) Pub. Date: Jul. 22, 2021

(54) DEVICE FOR SHAPING AND CLAMPING RIM EXTRUDING STRIP

(71) Applicant: ALEX GLOBAL TECHNOLOGY, INC., TAINAN CITY (TW)

(72) Inventor: WEI-CHIN CHEN, TAINAN CITY (TW)

(21) Appl. No.: 16/745,948

(22) Filed: Jan. 17, 2020

(51) Int. Cl. B21D 53/30; B21D 7/08

(52) U.S. Cl. CPC B21D 53/30; B21D 5/12; B21D 7/08

(57) ABSTRACT

A device for shaping and clamping a rim extruding strip is disclosed herein. It comprises a first pressure plate, a second pressure plate, a power source having a power output shaft and a first teeth part disposed on the power output shaft, wherein the power output shaft has a first end assembled to the first pressure plate and a second end passing through the second pressure plate; an actuation rod having a second teeth part, a first end passing through the first pressure plate, and a second end assembled to the second pressure plate; and a gearing wheel disposed between the first teeth part of the power output shaft and the second teeth part of the actuation rod.

### BACKGROUND OF THE INVENTION

1. Field of the Invention

The present invention relates to a device for shaping and clamping a rim extruding strip which clamps and shapes two sides of the rim extruding strip so that the rim extruding strip can smoothly enter a pipe bending mechanism for further processing to form an annular wheel rim.

2. Description of Related Art

In order to lighten bicycles, wheel rims are usually made of aluminum alloy or carbon fiber. In preparing aluminum alloy rims for bicycles, aluminum extrusion technique is usually used to form a long strip of aluminum material. Primarily, the aluminum material is cut into appropriate length and bent into an annular wheel rim according to the size of the rim, and then two ends of the bent aluminum material are connected by welding or riveting to form a wheel rim to be further assembled to a tire and spoke wires.

After the aluminum material has been extruded by heat, stretched and straightened, its molecular crystal arrangement has been fixed, but the width on its both sides increased slightly, resulting in the inability to enter a pipe bending mechanism smoothly for further bending into the annular wheel rim. Accordingly, the extruded aluminum material cannot be gripped by wheel sets of the pipe bending mechanism to enter the pipe bending mechanism. In such a case, it is necessary to manually strike on the two sides of each extruded aluminum material to reduce the diameter so as to allow the extruded aluminum material to be gripped smoothly. Therefore, the above method is complicated and time-consuming, and the inconsistent striking force easily causes deformation of the extruded aluminum material.

### SUMMARY OF THE INVENTION

In view of the above-mentioned problems, the object of the present invention is to provide a device for shaping and clamping a rim extruding strip which clamps and shapes two sides of the rim extruding strip to make the rim extruding strip conform to the design for smoothly entering a pipe bending mechanism.

The present invention is used for shaping and clamping a rim extruding strip before the rim extruding strip enters the pipe bending mechanism for further processing.

The device for shaping and clamping a rim extruding strip comprises: a first pressure plate and a second pressure plate for clamping or releasing two sides of a rim extruding strip; a power source having a power output shaft and a first teeth part disposed on the power output shaft, wherein the power output shaft has a first end assembled to the first pressure plate and a second end passing through the second pressure plate; an actuation rod having a first end passing through the first pressure plate, a second teeth part, and a second end assembled to the second pressure plate to fixedly assemble to the second pressure plate; and a gearing wheel disposed between the first teeth part and the second teeth part. Accordingly, the present invention can shape and clamp two sides of the rim extruding strip to make the rim extruding strip enter the pipe bending mechanism smoothly for bending and shaping.

According to an embodiment of the present invention, the power source is assembled to a base.

According to an embodiment of the present invention, the gearing wheel is disposed between the power output shaft and the actuation rod for being correspondingly engaged with the first teeth part and the second teeth part. Furthermore, an axis of the gearing wheel is pivotally connected to the base.

According to an embodiment of the present invention, each of the first pressure plate and the second pressure plate is provided with a pad made of rubber, polyurethane or both.

According to an embodiment of the present invention, the power source is a pressure cylinder.

### BRIEF DESCRIPTION OF THE DRAWINGS

FIG. 1 is a stereogram showing a device for shaping and clamping a rim extruding strip according to the present invention;

FIG. 2 is a schematic diagram showing a rim extruding strip entering a device for shaping and clamping a rim extruding strip according to the present invention;

FIG. 3 is a cross-sectional view showing a device for shaping and clamping a rim extruding strip according to the present invention;

FIG. 4 is a cross-sectional view showing a rim extruding strip in a clamped state according to the present invention;

FIG. 5 is a schematic diagram showing a rim extruding strip entering a pipe bending mechanism;

FIG. 6 is a schematic diagram showing a rim extruding strip further bent and shaped by a pipe bending mechanism.

### DETAILED DESCRIPTION OF THE PREFERRED EMBODIMENT

Hereinafter, an exemplary embodiment of the present invention will be described in detail with reference to the accompanying drawings.

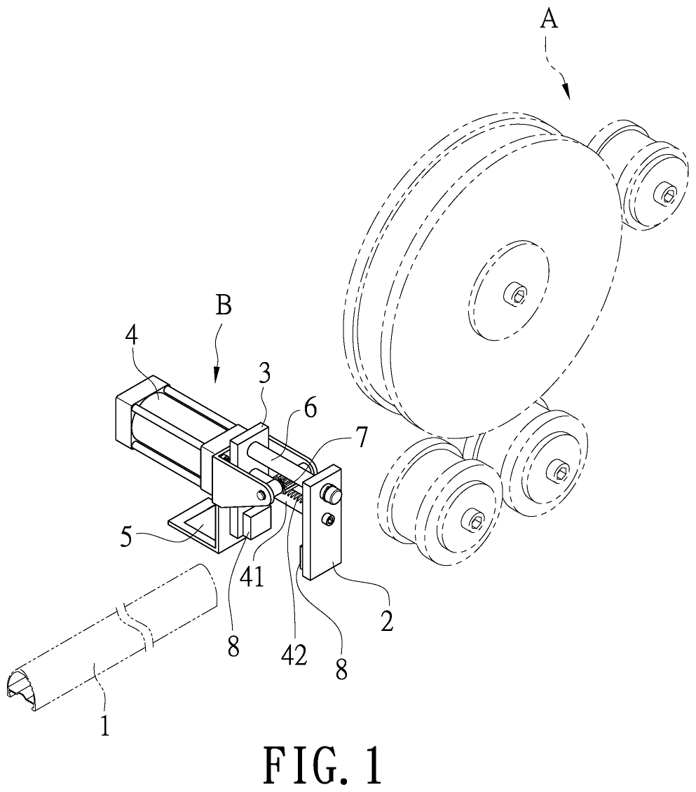

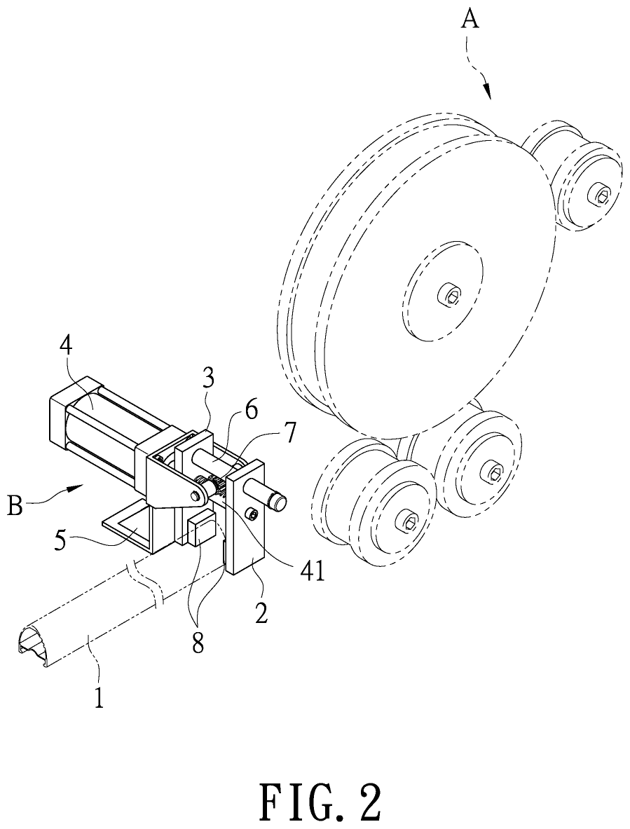

As showed in FIG. 1 to FIG. 4, a device for shaping and clamping a rim extruding strip (B) according to the present invention is disclosed herein. It is used for shaping and clamping a rim extruding strip (1) before the rim extruding strip (1) enters a pipe bending mechanism (A) for further processing. The device for shaping and clamping a rim extruding strip (B) comprises a first pressure plate (2) and a second pressure plate (3) for clamping or releasing two sides of the rim extruding strip (1). When the first pressure plate (2) is driven by power to move and synchronously drives the second pressure plate (3) to correspondingly move toward the first pressure plate (2) to clamp the rim extruding strip (1) or away from the first pressure plate (2) to release the rim extruding strip (1).

In order to achieve the above-mentioned purpose of driving the first pressure plate (2) and the second pressure plate (3) to synchronously clamp or release the rim extruding strip (1), the following embodiment is provided. The device for shaping and clamping a rim extruding strip (B) further comprises: a power source (4) having a power output shaft (41) and a first teeth part (42) disposed on the power output shaft (41), wherein the power output shaft (41) has a first end fixedly assembled to the first pressure plate (2) and a second end passing through the second pressure plate (3); a base (5) assembled with the power source (4) and located ahead of the position of the pipe bending mechanism (A); an actuation rod (6) having a first end passing through the first pressure plate (2), a second teeth part (61), and a second end fixedly assembled to the second pressure plate (3); and a gearing wheel (7) disposed between the power output shaft (41) and the actuation rod (6) for being correspondingly engaged with the first teeth part (42) and the second teeth part (61). An axis of the gearing wheel (7) is pivotally connected to the base (5).

Referring to FIG. 1 to FIG. 6, in use of the present invention, the device for shaping and clamping a rim extruding strip (B) is installed ahead of the position of the pipe bending mechanism (A), so the rim extruding strip (1) is processed by the present invention before entering the pipe bending mechanism (A). The base (5) is installed with the power source (4). The second end of the power output shaft (41) passes through the second pressure plate (3), and the second end of the actuation rod (6) is fixedly assembled to the second pressure plate (3). Furthermore, the first teeth part (42) disposed on the power output shaft (41) and the second teeth part (61) of the actuation rod (6) are engaged with the gearing wheel (7), and the axis of the gearing wheel (7) is pivotally connected to the base (5). Finally, the first end of the actuation rod (6) passes through the first pressure plate (2), and the first pressure plate (2) is fixedly assembled at the first end of the power output shaft (41). Each of the first pressure plate (2) and the second pressure plate (3) is further provided with a pad (8), and the pad (8) is preferably made of rubber, polyurethane or both.

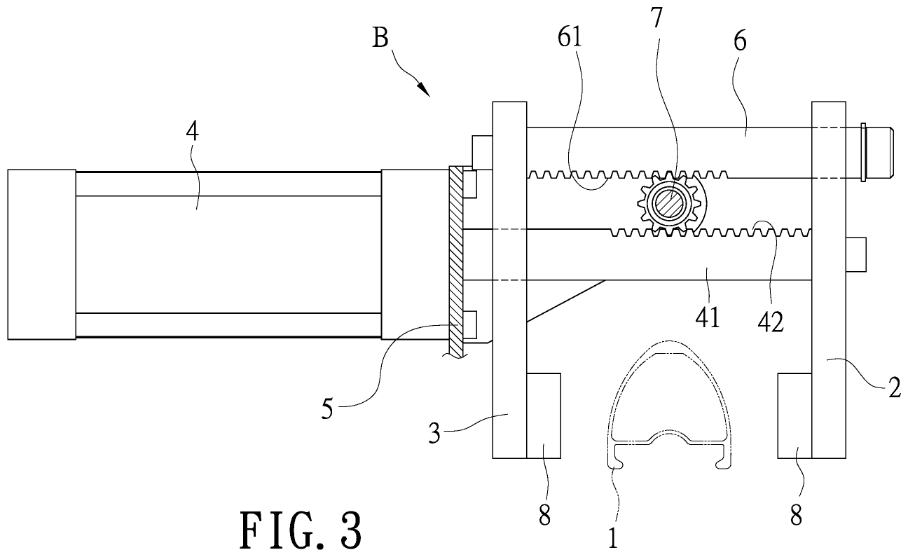

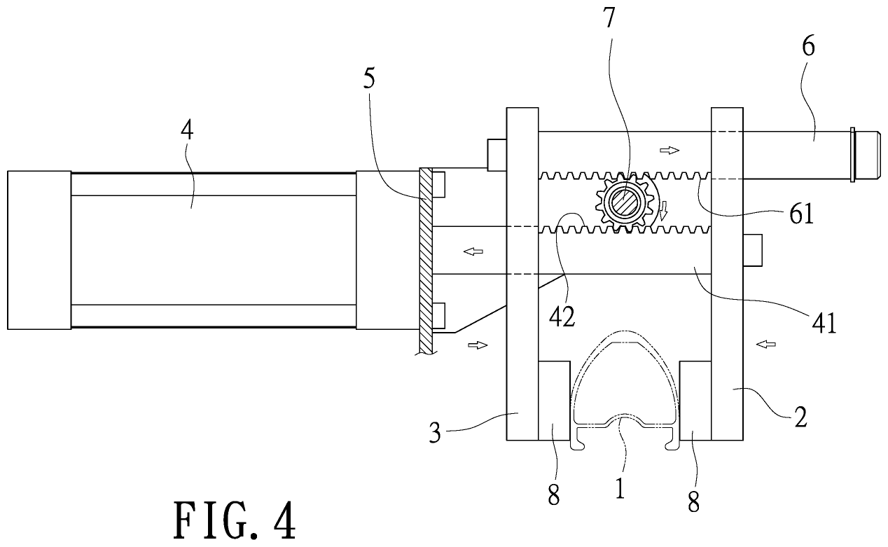

In actuation as shown in FIG. 3 and FIG. 4, after the rim extruding strip (1) enters the device for shaping and clamping a rim extruding strip (B), the power source (4) (a pressure cylinder) is turned on to drive the power output shaft (41) moves inward (move to the left in FIG. 4 as shown by an arrow) to further drive the first pressure plate (2) to move toward the second pressure plate (3) to clap the rim extruding strip (1). The inward movement of the power output shaft (41) also drives the gearing wheel (7) to rotate clockwise by engaging with the first teeth part (42), and thus the gearing wheel (7) further drives the actuation rod (6) to move outward by engaging with the second teeth part (61). In such a case, the first end of the actuation rod (6) passing through the first pressure plate (2) moves outward to bring the second pressure plate (3) to move toward the first pressure plate (2), so that the first pressure plate (2) and the second pressure plate (3) are close to each other to clamp the rim extruding strip (1) by the pads (8) for shaping. Therefore, the diameter of the two sides of the rim extruding strip (1) can meet the wheel set of the pipe bending mechanism (A).

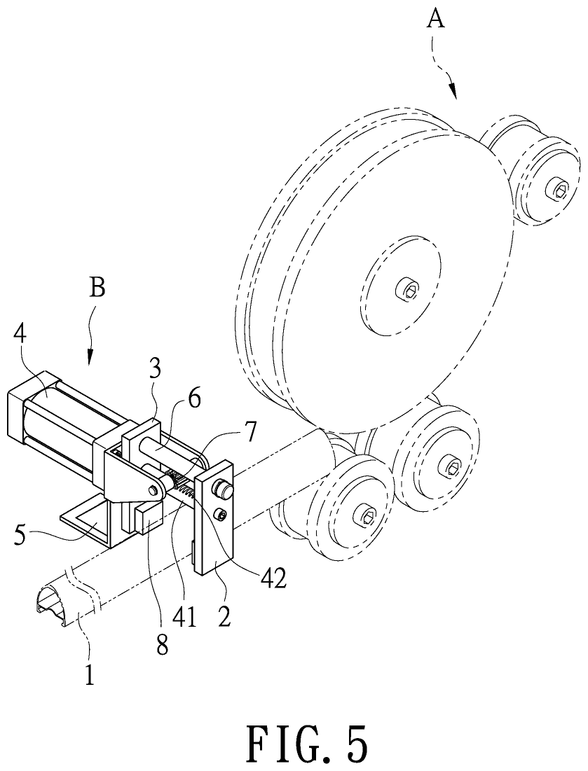

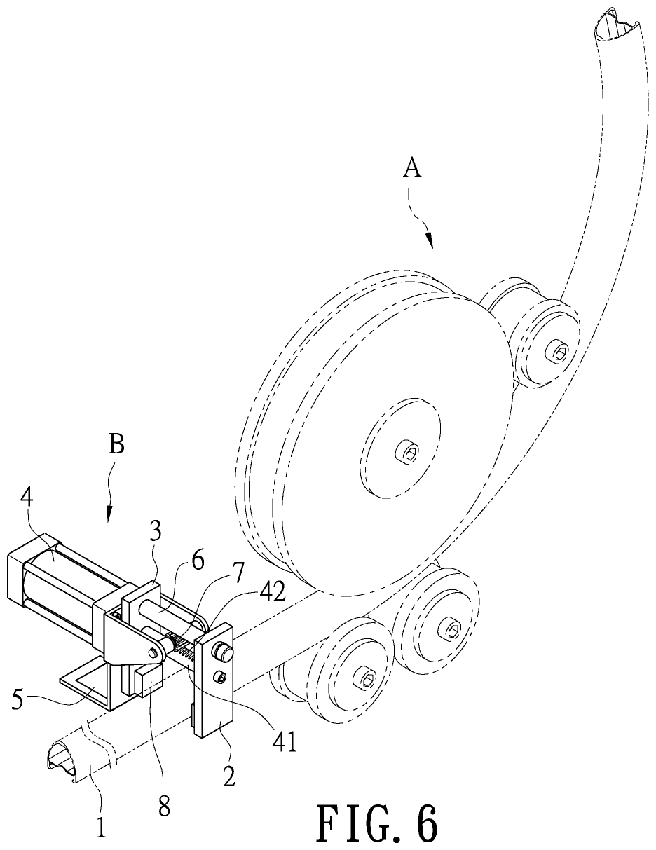

As shown in FIG. 5 and FIG. 6, the two sides of a head portion of the rim extruding strip (1) are clamped and then immediately released by the power output shaft (41) moving outward (move to the right in FIG. 5 and FIG. 6) to drive the first pressure plate (2) to move outward and away from the second pressure plate (3). The outward movement of the power output shaft (41) also drives the gearing wheel (7) to rotate counterclockwise by engaging with the first teeth part (42), and thus the gearing wheel (7) further drives the actuation rod (6) to move inward by engaging with the second teeth part (61). In such a case, the first end of the actuation rod (6) passing through the first pressure plate (2) moves inward to bring the second pressure plate (3) to move toward the power source (4), so that the first pressure plate (2) and the second pressure plate (3) are away from each other to release the rim extruding strip (1) by the pads (8). Therefore, the rim extruding strip (1) can enter the pipe bending mechanism (A) smoothly for further bending into an annular wheel rim.

Furthermore, the embodiment above merely proves the practice scope of this invention, but it is not intended to limit the scope thereto. The first pressure plate (2) and the second pressure plate (3) can relatively move toward or separate from each other in various ways. For instance, different from the above embodiment, the power output shaft (41) can be fixedly assembled to the first pressure plate (2) by the second end, and the actuation rod (6) can be fixedly assembled to the second pressure plate (3) by the first end. In this way, the moving directions of the actuation rod (6) and the power output shaft (41) will be opposite to the moving directions of the actuation rod (6) and the power output shaft (41) in the above embodiment. Furthermore, the first pressure plate (2) and the second pressure plate (3) can be respectively driven to move simultaneously by two power sources (4).

What is claimed is:

1. A device for shaping and clamping a rim extruding strip, comprising:
a first pressure plate and a second pressure plate for clamping or releasing two sides of a rim extruding strip before the rim extruding strip enters a pipe bending mechanism for further bending into an annular wheel rim, wherein the first pressure plate is driven by power to move and synchronously drives the second pressure plate to correspondingly move toward the first pressure plate to clamp the rim extruding strip or away from the first pressure plate to release the rim extruding strip.

2. The device for shaping and clamping a rim extruding strip as claimed in claim 1, further comprising:
a power source having a power output shaft and a first teeth part disposed on the power output shaft, wherein the power output shaft has a first end assembled to the first pressure plate and a second end passing through the second pressure plate;
a base assembled with the power source;
an actuation rod having a first end passing through the first pressure plate, a second teeth part for correspondingly engaging with the first teeth part disposed on the power output shaft, and a second end assembled to the second pressure plate; and
a gearing wheel disposed between the power output shaft and the actuation rod for being correspondingly engaged with the first teeth part and the second teeth part, wherein an axis of the gearing wheel is pivotally connected to the base.

3. The device for shaping and clamping a rim extruding strip as claimed in claim 2, wherein each of the first pressure plate and the second pressure plate is provided with a pad made of rubber, polyurethane or both.

4. The device for shaping and clamping a rim extruding strip as claimed in claim 3, wherein the power source is a pressure cylinder.
